(19) United States
(12) Patent Application Publication
(10) Pub. No.: US 2015/0365275 A1
(43) Pub. Date: Dec. 17, 2015

(54) CLOUD ENVIRONMENT CONFIGURATION FOR CLOUD APPLICATIONS

(71) Applicants: HRISTO ILIEV, Sofia (BG); INA IVANOVA, Russe (BG); MARIA JUROVA, Sofia (BG)

(72) Inventors: HRISTO ILIEV, Sofia (BG); INA IVANOVA, Russe (BG); MARIA JUROVA, Sofia (BG)

(21) Appl. No.: 14/302,427

(22) Filed: Jun. 12, 2014

(51) Int. Cl. H04L 12/24

(52) U.S. Cl. CPC H04L 41/0803

(57) ABSTRACT

Various embodiments of systems and methods for cloud environment configuration for cloud application are described herein. In an aspect, the method includes receiving a request for starting a cloud application. In response to the received request, binaries of the cloud application are invoked and the cloud environment configuration for the cloud application is identified. It is determined whether the binaries of the cloud application are to be uploaded independently of its cloud environment configuration. When the binaries are to be uploaded independently of its cloud environment configuration, the binaries and the cloud environment configuration are uploaded separately in different transactions onto cloud. In case the binaries are not to be uploaded independently of its cloud environment configuration, an archive including the binaries and the cloud environment configuration is generated and uploaded onto the cloud.

### BACKGROUND

Cloud environment configuration refers to various cloud parameters set for executing a cloud application. The cloud environment configuration determines the properties and behavior of the cloud environment for the cloud application. Usually, the cloud environment configuration is bundled with the cloud application and therefore, there is no flexibility to reuse the cloud environment configuration. It is not possible to access the cloud environment configuration when the cloud application is removed or deleted. Often, for modifying the cloud environment configuration it is required to modify the cloud application and redeploy it, which is inefficient and time consuming task. Moreover, due to tight coupling of cloud environment configuration and cloud application, developers need to be aware of the cloud environment configuration while coding cloud applications.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 illustrates an exemplary application hosting environment including a deploy module for hosting a cloud application and corresponding cloud environment configuration onto cloud, according to an embodiment.

FIG. 2 illustrates an application hosting environment for hosting a cloud application and corresponding cloud environment configuration, according to another embodiment.

FIG. 3 illustrates a cloud server for downloading and storing binaries and cloud environment configuration for a cloud application, according to an embodiment.

FIG. 4 is a flow chart illustrating a process of hosting cloud application and corresponding cloud environment configuration onto cloud, according to an embodiment.

FIG. 5 is a flow chart illustrating a process of reconfiguring a cloud environment configuration, according to an embodiment.

FIG. 6 is a block diagram illustrating an exemplary compute system, according to an embodiment.

### DESCRIPTION

Embodiments of techniques for cloud environment configuration for cloud applications are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

“Cloud application” refers to an application that functions in the cloud. The cloud application can be accessed through a web browser from a communication device connected to the Internet. The cloud application may be provided as software-as-a-service (SaaS) application, platform-as-a-service (PaaS) application, or infrastructure-as-a-service (IaaS) application. In an embodiment, the cloud application may be termed as “cloud for customer,” “cloud onDemand (COD),” or “onDemand” application. The cloud application includes binaries (executable codes), application data, and application configuration. In various embodiments, the binaries include application data and application configuration.

“Application configuration” refers to parameters which describe application properties and display, e.g., display of various components or icons of the cloud application, cloud application logging information, and color, font, and size of the text rendered on the cloud application, etc. The application configuration is specific to a cloud application.

“Cloud environment configuration” refers to cloud parameters which describe properties and behavior of cloud for executing a cloud application. For example, the cloud environment configuration may include, but is not limited to, cloud location, runtime library, executable software routines version, virtual memory size, application server, application server version, operating system (OS) version, database address or database URL (uniform resource locator), number of parallel processes, etc. The cloud environment configuration is defined for the cloud application and the cloud application is executed according to its cloud environment configuration.

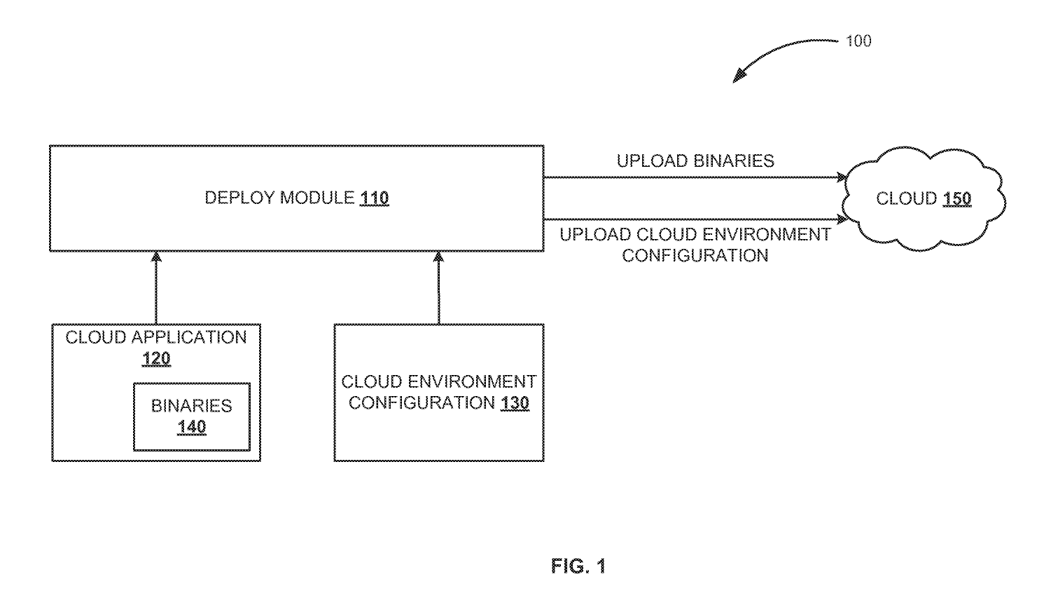

FIG. 1 is a block diagram illustrating exemplary application hosting environment 100 including a deploy module 110 for installing cloud application 120 and its corresponding cloud environment configuration 130 onto cloud 150. In an embodiment, the deploy module 110 receives a request to start the cloud application 120, in an embodiment, “start” refers to at least one of setting-up, launching, deploying, and hosting. Upon receiving the request, the deploy module 110 invokes binaries 140 of the cloud application 120. The term “invoke” refers to at least one of identify, access, scan, and extract. The deploy module 110 also identifies the cloud environment configuration 130 related to the cloud application 120. Based upon the request, the deploy module 110 determines whether to upload the binaries 140 independently of the cloud environment configuration 130. In an embodiment, the request indicates whether the binaries 140 are to be uploaded independently from the cloud environment configuration 130. In various embodiments, “uploaded independently” refers to at least one of packaged independently and uploaded separately in different transactions. When the binaries 140 are to be uploaded independently from the cloud environment configuration 130, the deploy module 110 uploads the binaries 140 and the cloud environment configuration 130 separately in different transactions onto the cloud 150. The binaries 140 and the cloud environment configuration 130 are downloaded by a cloud server (not shown) and stored in a cloud repository (not shown). Once the binaries 140 and the cloud environment configuration 130 are stored in the cloud repository, the cloud application 120 gets hosted and can be accessed and executed through the Web or any network.

The cloud application 120 may be an onDemand or SaaS application. The cloud application 120 includes application code or binaries, application data, and application configuration. The binaries are executable files which comprises machine readable code to render the cloud application 120. For example, the binaries may be an executable file “webshop.exe” which can be executed to render a cloud application “web-based shop.” The application data may provide the descriptions or details to be rendered on the cloud application, e.g., descriptions of the products, prices of the products, and images of the products in the web-based shop. The application configuration describes properties and display characteristics of the cloud application, e.g., placement of products or icons on a user interface, color, font, and text size of the displayed text, etc. In an embodiment, the binaries include the application data and the application configuration. In an embodiment, the application configuration may be hardcoded within the binaries or may be provided as one of a file within the binaries and a database object. The binaries including the application data and the application configuration can be uploaded onto the cloud. The binaries are uploaded along with the cloud environment configuration of the cloud application to host the cloud application onto the cloud.

The cloud environment configuration is defined for one or more cloud applications. For example, the cloud environment configuration 130 may be defined for the cloud application 120. The cloud application 120 is executed according to its cloud environment configuration 130. The cloud environment configuration 130 may include a reference (e.g., a name or an identifier) of the cloud application 120 for which the cloud environment configuration 130 is defined or applicable. The cloud environment configuration 130 may include names of a plurality of cloud applications for which it is applicable. Alternately, there may be a plurality of cloud environment configurations for a single cloud application. Therefore, the relationship between the cloud environment configuration and the cloud application may be any one of one to one (1:1), one to many (1:N) and many to one (N:1), where N is any natural number greater than 1. The deploy module 110 may know the relation between the cloud application and the cloud environment configuration. For example, the deploy module 110 knows which cloud environment configuration is defined for which cloud application.

The deploy module 110 uploads the cloud application 120 and its cloud environment configuration 130 onto the cloud 150. The deploy module 110 can perform at least one of identifying, uploading, launching, hosting, setting-up, deploying, accessing, and extracting the cloud application 120 and its cloud environment configuration 130. In an embodiment, the deploy module 110 includes one or More APIs (application programming interfaces) to enable users configure, reconfigure, or access the binaries 140 and the cloud environment configuration 130 for the cloud application 120. In an embodiment, the binaries 140 and the cloud environment configuration 130 can be configured, reconfigured, or accessed by providing commands through a command line interface (CLI), visual user interface, or mobile device making use of the deploy module 110.

In an embodiment, the deploy module 110 receives the request for starling the cloud application 120. In an embodiment, starting refers to hosting, launching, deploying, or setting up. The request may be provided through an API or the CLI of the deploy module 110. For example, a command may be provided through the CU to request to deploy the cloud application 120. An exemplarily command for deploying the cloud application may be “deploy application <application_name> source <name_of_executable_file or binaries> configuration <cloud_environment_configuration_file>”. For example, for deploying the cloud application “web_shop” having executable file “webshop.exe” with cloud environment configuration stored in file “webshop.cfg”, the command or request “deploy application web_shop source webshop.exe configuration webshop.cfg” may be provided through the CLI.

In response to receiving the request, the deploy module 110 invokes the binary 140 (e.g., webshop.exe) of the cloud application 120 (e.g., web_shop). In an embodiment, “invoking” refers to at least one of identifying accessing, scanning, and extracting. The deploy module 110 identifies the cloud environment configuration 130 (e.g., webshop.cfg) for the cloud application 120. The deploy module 110 identifies the cloud environment configuration 130 by identifying reference (e.g., name) of the cloud application 120 associated with the cloud environment configuration 130. Upon identifying the cloud environment configuration 130, the deploy module 110 determines whether the request includes a requirement for uploading independently the cloud environment configuration 130 and the binaries 140. In an embodiment, the request includes a field to indicate whether the cloud environment configuration 130 and the binaries 140 are to be uploaded independently or not.

When the binaries 140 are to be uploaded independently from the cloud environment configuration 130, the deploy module 110 uploads the binaries 140 and the cloud environment configuration 130 separately in different transactions onto the cloud 150. The different transactions may be executed subsequently or in parallel. The binaries 140 and cloud environment configuration 130 are packaged independently and separately. In an embodiment, the deploy module 110 generates separate archive for the binaries 140 and cloud environment configuration 130, and then independently uploads these archives onto the cloud in different transactions. In an embodiment, the user specifies through the deploy module 110 API whether to archive the binaries and the cloud environment configuration separately. In an embodiment, the deploy module 110 validates the binaries 140 and cloud environment configuration 130 before generating their respective archives or before independently uploading them onto the cloud 150. In case of successful validation, the deploy module 110 uploads independently the binaries 140 and cloud environment configuration 130 onto the cloud 150. However, when the validation is unsuccessful, the deploy module 110 may display an error message and cancel the deployment.

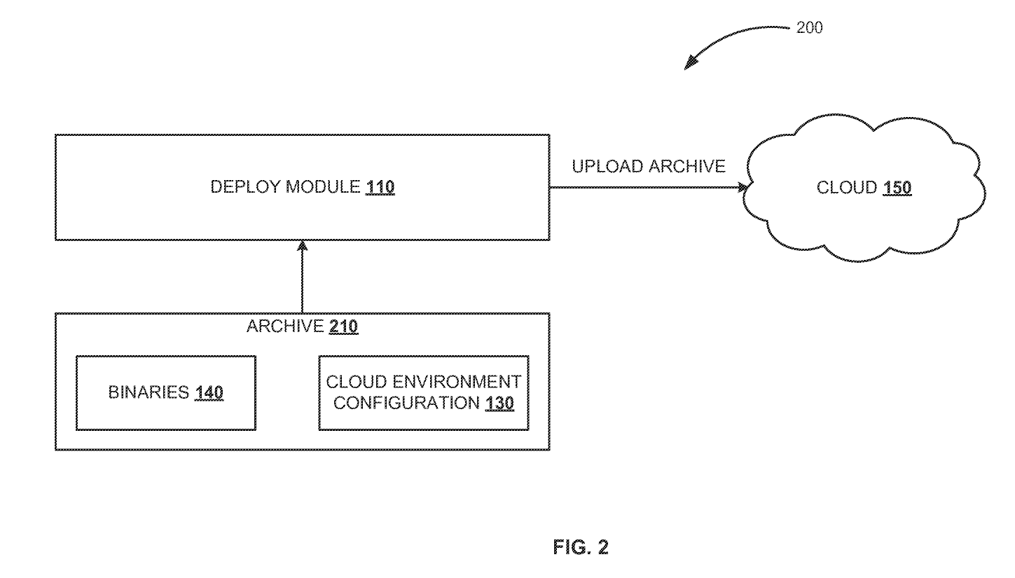

FIG. 2 shows exemplary application hosting environment 200 for installing cloud application 120 and its corresponding cloud environment configuration 130 onto cloud 150, according to another embodiment. When the deploy module 110 determines that the binaries 140 are not to be uploaded independently from the cloud environment configuration 130, the deploy module 110 generates archive 210 including both the binaries 140 and the cloud environment configuration 130. The generated archive 210 is then uploaded onto the cloud 150. In an embodiment, the deploy module 110 validates the binaries 140 and cloud environment configuration 130 before generating the archive 210. When the validation is successful, the deploy module 110 generates the archive 210 and uploads the generated archive 210 onto the cloud 150. However, when the validation is unsuccessful, the deploy module 110 may display the error message and cancel the deployment.

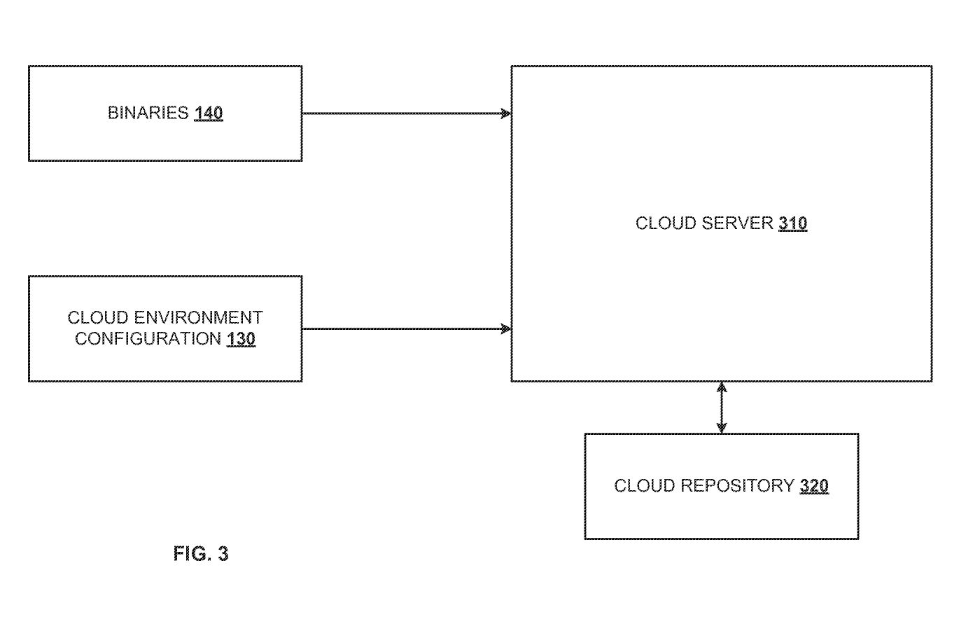

FIG. 3 is a block diagram illustrating cloud server 310 for downloading the binaries 140 and the cloud environment configuration 130 from the cloud 150 and storing them in cloud repository 320. In an embodiment, once the binaries 140 and the cloud environment configuration 130 are uploaded onto the cloud 150, the cloud server 310 downloads the binaries 140 and the cloud environment configuration 130 from the cloud 150. The downloaded binaries 140 and the cloud environment configuration 130 are stored in the cloud repository 320. In an embodiment, the cloud server 310 extracts the binaries 140 and the cloud environment configuration 130 from the archive 210 (FIG. 2) and stores them in the cloud repository 320. In an embodiment, the cloud repository may be a file storage, a blob store, or a database. In an embodiment, the binaries 140 and the cloud environment configuration 130 are stored separately in the cloud repository 320. In an embodiment, the cloud server 310 validates the downloaded binaries 140 and the cloud environment configuration 130 before storing them in the cloud repository 320. In case of successful validation, the cloud server 310 stores them in the cloud repository 320, otherwise, the cloud server 310 returns an error to the deploy module 110 to notify that the upload failed due to unsuccessful validation. In an embodiment, the details of unsuccessful validation may be returned. Once notified, the deploy module 110 displays ‘uploading failed’ and/or details of unsuccessful validation on the UI. In an embodiment, the cloud server may be a deploy server. In various embodiments, the cloud environment configuration 130 comprises metadata which is downloaded from the cloud 150 and stored in the cloud repository 320.

The stored binaries 140 and the cloud environment configuration 130 can be accessed or reconfigured through the deploy module 110. In an embodiment, deploy module 110 includes APIs for accessing or reconfiguring the binaries 140 and the cloud environment configuration 130. In an embodiment, the binaries 140 and the cloud environment configuration 130 can be accessed or reconfigured through command line interface (CLI), web page, or mobile device using the deploy module 110. For example, a command “neo display application-properties host <landscape_host> account <account_name> application <application_name> user <e-mail_or_password>” may be provided for accessing or displaying cloud environment configuration of the cloud application. In the above exemplarily command “neo” indicates command initiating term on HANA® cloud platform, developed and marketed by the software company SAP AG. Further, “application-properties” refers to cloud environment configuration of the cloud application, “host” indicates a cloud or a landscape_host name from where the application properties is to be retrieved, account name indicates a name provided by the user to refer to the cloud application, application_name indicates the name of the application which properties (cloud environment configuration) is to be retrieved, and user email or password is provided to prevent unauthorized access.

Similarly, a command “neo change application-configuration application <application_name> configuration <changed configuration>” may be provided to reconfigure the cloud environment configuration of the cloud application. In the above exemplarily command, “application-configuration” refers to cloud environment configuration of the cloud application, “application-configuration” may be replaced by the term “application-properties”, “application_name” indicates the name of the cloud application whose cloud environment configuration is to be changed, “configuration” indicates a new or updated configuration to replace the old cloud environment configuration with the changed cloud configuration. For example, for changing the cloud environment configuration such as min-number-of-instance to 3 and max-number-of-instances to 10 for the cloud application “web_shop”, a command “change application-configuration application web_shop configuration min-number-of-instance 3 max-number-of-instances 10” may be provided. In an embodiment, the user can make changes in the cloud environment configuration file and provide the updated or changed file in the command as “change application-configuration application web_shop configuration webshop.cfg” for changing the configuration. In an embodiment, the cloud server 310 includes one or more APIs to configure, reconfigure, or access the binaries 140 and the cloud environment configuration 130. In fact, the binaries 140 and the cloud environment configuration 130 can be configured, reconfigured, or accessed using the APIs of the cloud server 310 via web by providing commands through the CLI, UI, or mobile device making use of the deploy module 110.

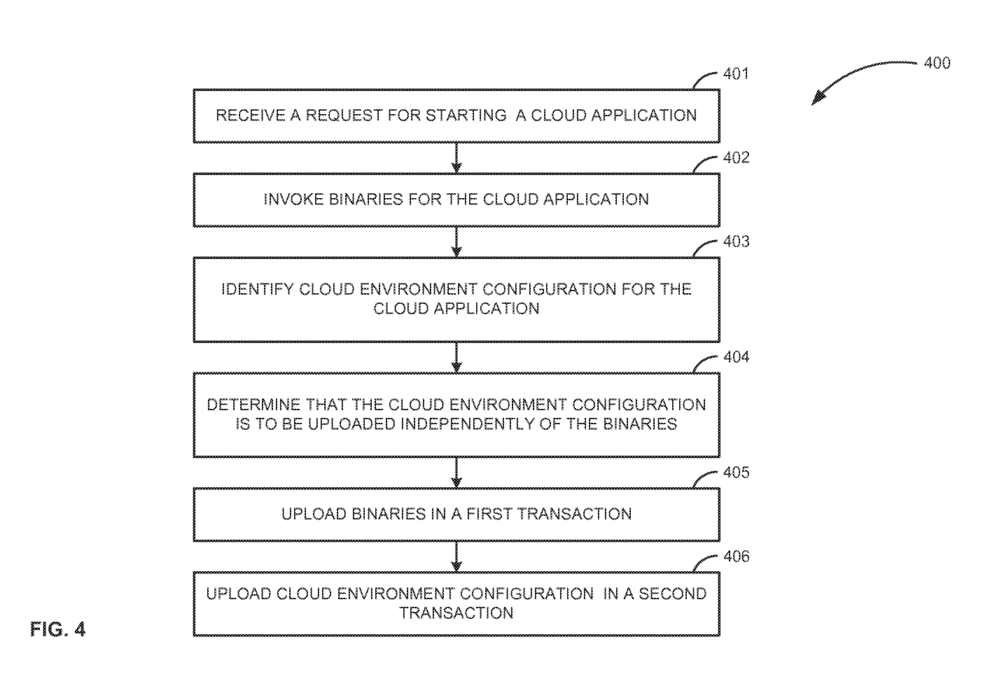

FIG. 4 is a flowchart illustrating process 400 to host a cloud application (e.g., cloud application 120 of FIG. 1) and corresponding cloud environment configuration (e.g., cloud environment configuration 130 of FIG. 1) onto cloud. The hosting may be enabled by a deploy module (e.g., deploy module 110 of FIG. 1). At 401, a request for starting the cloud application is received. In an embodiment, “starting” refers to at least one of setting-up, launching, deploying, and hosting. At 402, upon receiving the request, binaries (e.g., binaries 140 of FIG. 1) of the cloud application (e.g., application 120) are invoked (e.g., by the deploy module 110). The term “invoke” refers to at least one of: identify, access, scan, and extract. Further, the cloud environment configuration (e.g., cloud environment configuration 130 of FIG. 1) related to the cloud application is identified at 403 (e.g., the by deploy module 110).

In one embodiment, based upon the request, it is determined (e.g., by the deploy module) whether to upload the binaries independently of the cloud environment configuration. For example, the request may include afield to indicate whether the binaries are to be independently uploaded from its cloud environment configuration. In various embodiments, “uploading independently” refers to at least one of: packaged independently, and uploading separately in different transactions. Upon determining at 404 that the binaries are to be uploaded independently from the cloud environment configuration, the binaries are uploaded in a first transaction, at 405. Consequently or preceding, or in parallel, the cloud environment configuration is separately uploaded in a second transaction, at 406.

The uploaded binaries and the cloud environment configuration may be downloaded by a cloud server (e.g., cloud server 310 of FIG. 3) and stored in a cloud repository (e.g., cloud repository 320 of FIG. 3). In one embodiment, the cloud server validates the binaries and the cloud environment configuration before storing them in the cloud repository. In case of unsuccessful validation, the cloud server returns an error to the deploy module to notify uploading failure due to unsuccessful validation. In one embodiment, the details of unsuccessful validation may also be notified. In case of successful validation, the cloud server stores the binaries and the cloud environment configuration in the cloud repository. Once the binaries and the cloud environment configuration are stored in the cloud repository, the cloud application is hosted on the cloud and can be executed and accessed through the Web.

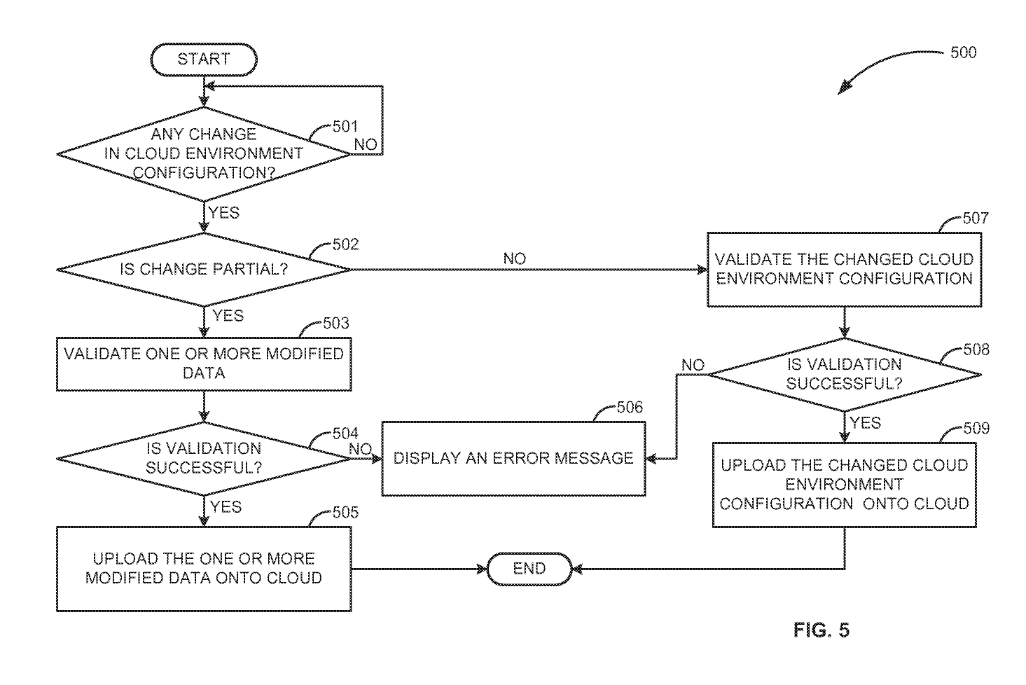

FIG. 5 is a flowchart illustrating process 500 to change or reconfigure cloud environment configuration for a cloud application. A deploy module (e.g., deploy module 110 of FIG. 1) receives a request for reconfiguring the cloud environment configuration. Upon receiving the request, the deploy module retrieves the cloud environment configuration from the cloud server. A user can reconfigure or change the downloaded cloud environment configuration. At 501, a check is performed, e.g., by the deploy module, to determine whether there is any change in the downloaded cloud environment configuration done by the user. When there is change (501: YES), the deploy module determines whether the change is partial at 502. The partial change refers to change in one or more parameters of the cloud environment configuration. When the change is partial (502: YES), the deploy module validates changed or modified data at 503. At 504, it is determined whether the validation is successful. When the validation is successful (504: YES), the deploy module uploads the modified data onto the cloud at 505. In an embodiment, the cloud server downloads the modified data and updates the data in the cloud repository, accordingly, without modifying other parameters or data. In case the validation is unsuccessful (504: NO), an error message is displayed by the deploy module at 506.

In an embodiment, the change can be non-partial. The non-partial change refers to a complete change in the cloud environment configuration, i.e., entire cloud configuration is changed. When the change is non-partial (502: NO), the deploy module validates the changed cloud environment configuration at 507. At 508, is determined if the validation is successful. When the validation is successful (508: YES), the deploy module uploads the modified cloud environment configuration onto the cloud at 509. The cloud server downloads the changed or modified cloud environment configuration and replaces the cloud environment configuration with the changed cloud environment configuration in the cloud repository. In case the validation is unsuccessful (508: NO), an error message is displayed by the deploy module at 506.

Embodiments enable isolating cloud applications from their corresponding cloud environment configuration. The isolation provides flexibility to code, change, modify, configure, reconfigure, host, set-up, deploy, or update the cloud environment configuration without affecting the cloud application and vise-versa. The reconfiguration of the cloud environment configuration can be done without redeployment of the cloud application. Further, the cloud environment configuration can be reused or accessed by other cloud applications as well. Due to isolation, the developers need not know about the cloud environment configuration while coding the cloud application. In fact, the application development and the application operation (environment configuration process) are separated, and therefore, different companies or units can be separately focused on development and configuration operations, respectively. Moreover, operators and developers have flexibility to change and adopt different strategies and approaches. For example, they can decide to keep the same cloud application for a country and change just the cloud environment configuration such as number of processes if the cloud application is expected to be used by more people in that country. Independent handling of the cloud environment configuration and the cloud application reduces total cost of ownership (TCO), saves time, increases efficiency, and is user friendly.

In various embodiments, the cloud environment configuration can be easily and quickly viewed using suitable APIs (application programming interfaces). Similarly, the cloud application can be independently viewed or changed. Various embodiments enable to automatically validate the changes and maintain history of changes so that changes can be easily tracked or reverted to. In various embodiments, the isolation or loose coupling is provided on exclusive request otherwise the cloud application and its cloud environment configuration is coupled tightly using conventional technique.

Some embodiments may include the above-described methods being written as one or More software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or More sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic indicator devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

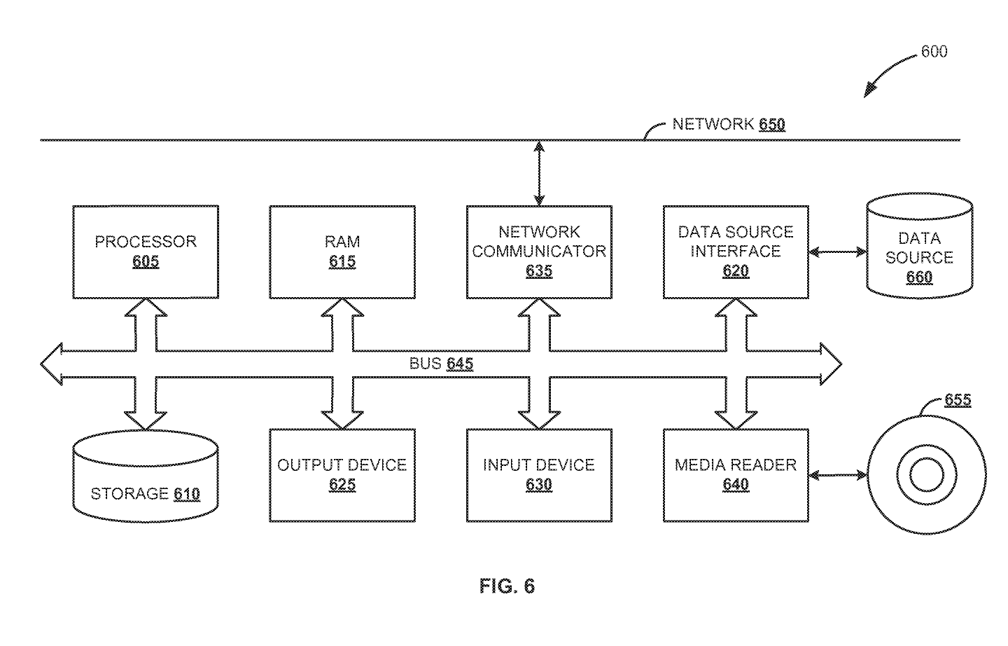

FIG. 6 is a block diagram of an exemplary computer system 600. The computer system 600 includes a processor 605 that executes software instructions Of code stored on a computer readable storage medium 655 to perform the above-illustrated methods. The processor 605 can include a plurality of cores. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. According to some embodiments, such as some in-memory computing system embodiments, the RAM 615 can have sufficient storage capacity to store much of the data required for processing in the RAM 615 instead of in the storage 610. In some embodiments, all of the data required for processing may be stored in the RAM 615. The stored instructions may be further compiled to generate other representations of the instructions and dynamically stored in the RAM 615. The processor 605 reads instructions from the RAM 615 and performs actions as instructed. According to one embodiment the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed by network 650. In some embodiments the data source 660 may be accessed via an abstraction layer, such as, a semantic layer.

A data source is an information resource. Data sources include sources of data that enable data storage and retrieval. Data Sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Database Connectivity (ODBC), produced by an underlying software system, e.g., an ERP system, and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the one or more embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or More embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the embodiment are described herein for illustrative purposes, various equivalent modifications are possible within the scope of the embodiments, as those skilled in the relevant art will recognize. These modifications can be made to the embodiments in light of the above detailed description. Rather, the scope of the one or more embodiments is to be determined by the following claims, which are to be interpreted in accordance with established doctrines of claim construction.

What is claimed is:

1. A non-transitory computer readable storage medium storing instructions, which when executed by a computer cause the computer to perform operations comprising:
receive a request for starting a cloud application;
in response to the request, invoke binaries for the cloud application;
identify a cloud environment configuration for the cloud application;
determine whether the received request includes a request for uploading the cloud environment configuration independently of the binaries; and
upon determining that the received request includes the request for uploading the cloud environment configuration independently of the binaries, perform operations comprising:
uploading the binaries in a first transaction; and
uploading the cloud environment configuration in a second transaction,
wherein the second transaction is different from the first transaction.

2. The computer readable medium of claim 1, wherein invoking includes at least one of identifying, accessing, and extracting, and wherein starting includes at least one of hosting, launching, setting up, and deploying.

3. The computer readable medium of claim 1 further comprising instructions which when executed by the computer cause the computer to perform operations comprising:
upon determining that the received request does not include the request for uploading the cloud environment configuration independently of the binaries, perform operations comprising:
generate an archive comprising the binaries and the cloud environment configuration; and
upload the generated archive onto cloud.

4. The computer readable medium of claim 1, wherein the cloud application comprises an on-demand application.

5. The computer readable medium of claim 1, wherein the cloud environment configuration comprises metadata related to cloud environment.

6. The computer readable medium of claim 5, wherein the uploaded binaries and the uploaded metadata are downloaded by a cloud server, validated by the cloud server, and stored in a cloud repository.

7. The computer readable medium of claim 1, wherein the binaries includes one or more of application data and application configuration.

8. The computer readable medium of claim 7, wherein the application configuration is included as application data within the binaries.

9. The computer readable medium of claim 1 further comprising instructions, which when executed by the computer cause the computer to perform operations comprising:
identifying change in the cloud environment configuration;
determining whether the change is complete or partial; and
upon determining complete change, performing operations comprising:
validating the changed cloud environment configuration;
upon successful validation, uploading the changed cloud environment configuration onto cloud, wherein a cloud server downloads the changed cloud environment configuration and replaces the cloud environment configuration with the changed cloud environment configuration in a cloud repository; and
upon unsuccessful validation, displaying an error message.

10. The computer readable medium of claim 9 further comprising:
upon determining partial change, performing operations comprising:
validating one or more modified data;
upon successful validation, uploading the one or more modified data onto the cloud, wherein the cloud server downloads the one or more modified data and updates the one or more modified data in the cloud repository; and
upon unsuccessful validation, displaying an error message.

11. A computer-implemented method for cloud configuration for cloud application comprising:
receiving a request for starting a cloud application;
in response to the request, invoking binaries for the cloud application;
identifying a cloud environment configuration for the cloud application;
determining that the received request includes a request for uploading the cloud environment configuration independently of the binaries;
uploading the binaries in a first transaction; and
uploading the cloud environment configuration in a second transaction, wherein the second transaction is different from the first transaction.

12. The computer-implemented method of claim 11 further comprising:
identifying change in the cloud environment configuration;
determining whether the change is complete or partial; and
upon determining complete change, performing operations comprising:
validating the changed cloud environment configuration;
upon successful validation, uploading the changed cloud environment configuration onto cloud, wherein a cloud server downloads the changed cloud environment configuration and replaces the cloud environment configuration with the changed cloud environment configuration in a cloud repository; and
upon unsuccessful validation, displaying an error message.

13. The computer-implemented method of claim 12 further comprising:
upon determining partial change, performing operations comprising:
validating one or more modified data;
upon successful validation, uploading the one or more modified data onto the cloud, wherein the cloud server downloads the one or more modified data and updates the one or more modified data in the cloud repository; and
upon unsuccessful validation, displaying an error message.

14. A computer system for cloud environment configuration for cloud app cation comprising:
at least one memory to store executable instructions; and
at least one processor communicatively coupled to the at least one memory, the at least one processor configured to execute the executable instructions to:
receive a request for starting a cloud application;
in response to the request, invoke binaries for the cloud application;
identify a cloud environment configuration for the cloud application;
determine whether the received request includes a request for uploading the cloud environment configuration independently of the binaries;
upon determining that the received request includes the request for uploading the cloud environment configuration independently of the binaries, perform operations comprising:
upload the binaries in a first transaction; and
upload the cloud environment configuration in a second transaction, wherein the second transaction is different from the first transaction.

15. The computer system of claim 14, wherein the at least one processor is further configured to execute the executable instructions to:
upon determining that the received request does not include the request for uploading the cloud environment configuration independently of the binaries, perform operations comprising:
generating an archive containing the binaries and the cloud environment configuration; and
uploading the generated archive onto cloud.

16. The computer system of claim 14, wherein the cloud environment configuration comprises metadata related to cloud environment.

17. The computer system of claim 16, wherein the uploaded binaries and the uploaded metadata are downloaded by a cloud server, validated by the cloud server, and stored in a cloud repository.

18. The computer system of claim 14, wherein the binaries includes one or more application data and application configuration and wherein the application configuration is included as application data within the binaries.

19. The computer system of claim 14, wherein the at least one processor is further configured to execute the executable instructions to:
identify change in the cloud environment configuration;
determine whether the change is complete or partial; and
upon determining complete change, perform operations comprising:
validating the changed cloud environment configuration;
upon successful validation, uploading the changed cloud environment configuration onto cloud, wherein a cloud server downloads the changed cloud environment configuration and replaces the cloud environment configuration with the changed cloud environment configuration in a cloud repository; and
upon unsuccessful validation, displaying an error message.

20. The computer system of claim 19, wherein the at least one processor is further configured to execute the executable instructions to:
upon determining partial change, perform operations comprising:
validating one or more modified data;
upon successful validation, uploading the one or more modified data onto the cloud, wherein the cloud server downloads the one or more modified data and updates the one or more modified data in the cloud repository; and
upon unsuccessful validation, displaying an error message.
